(19) United States
(12) Patent Application Publication
(10) Pub. No.: US 2019/0083978 A1
(43) Pub. Date: Mar. 21, 2019

(54) MANUFACTURING OF MICROFLUIDIC DEVICE IN MULTI-STEP METHOD USING HESITATION INJECTION MOULDING

(71) Applicant: SABIC Global Technologies B.V., Bergen op Zoom (NL)

(72) Inventors: Peter Neerincx, Oisterwijk (NL); Bart van der Aar, Den Dungen (NL)

(21) Appl. No.: 16/095,233

(22) PCT Filed: Apr. 28, 2017
(86) PCT No.: PCT/IB2017/052493

§ 371 Date: Oct. 19, 2018

Related U.S. Application Data
(60) Provisional application No. 62/328,732, filed on Apr. 28, 2016.

(51) Int. Cl. B01L 3/00; B29C 45/16; B29C 45/14

(52) U.S. Cl. CPC B01L 3/502707; B29C 45/1671; B29C 45/1418; B01L 2200/0689; B29L 2031/756; B01L 2300/0627; B01L 2300/0816; B29C 2045/1673; B01L 2300/041

(57) ABSTRACT

Disclosed herein are methods for manufacture of microfluidic devices on a single injection molding machine to provide a ready-to-use microfluidic device, such as a “lab on a chip” device. In particular, it refers to a molding method comprising the step of disposing a planar barrier adjacent to a surface of the base layer and positioned to overlay at least a portion of the microchannel; and causing a material to be disposed on the base layer using hesitation injection molding to create a closing layer configured to overmold at least a portion of the planar barrier and a least a portion of the microchannel. It further refers to a method comprising the step of disposing a sensor adjacent a first surface of the base layer and molding a cover layer adjacent the first surface of the base layer to at least partially cover the sensor and to secure the sensor in position relative to the base layer.

### FIELD OF DISCLOSURE

The present disclosure relates to methods of manufacturing a microfluidic device. More specifically, the disclosure relates to methods comprising hesitation molding and film over-molding that allow the manufacture of microfluidic devices on a single injection molding machine without the need of any secondary manufacturing steps to provide a ready-to-use microfluidic device, such as a “lab on a chip” device.

### BACKGROUND

Miniaturization and integration of a complete diagnostic lab onto a credit-card sized chip requires fabrication of one or more microchannels to handle very small volumes of fluids. There are a handful of technologies currently used to fabricate microfluidic devices. First generation microfluidic chips were commonly created on silicon wafers. This manufacturing approach for microfluidic devices has the advantage of allowing for the precise replication of micro-structures in the device. However, silicon chip technology is hampered by the long lead times required from initial conception to manufacturing, as well as by process limitations that limit the incorporation of flexible parts and cost relative to other manufacturing methods.

In order to overcome the limitations of silicon chip technology, microfluidic devices may also be manufactured using etched glass methods. The use of etched glass overcomes many of the cost issues associated with silicon chip technology, as well as providing a transparent substrate which may be advantageous in some applications requiring optical measurements. However, compared to other manufacturing methods, etched glass manufacturing methods are also expensive.

Multilayer soft lithography with polydimethylsiloxane (PDMS) is an alternative technology used to fabricate microfluidic devices. The method utilizes a master mold created with using photoresist methods, and replication of the master mold using PDMS with a cross-liner followed by heat curing, stamping of inlet and outlet ports, and bonding the molded article to a glass substrate. Multilayer soft lithography is both faster and less expensive as a manufacturing method for microfluidic devices than either silicon chip technology or etched glass methods. Although it does not suffer from the same limitations associated with silicon chip technology, it is associated with severe limitations on the device design due to issues with sealing channels and the solvent compatibility of PDMS which may limit the scope of applications for the microfluidic device.

Finally, injection molding of polymers has been described for manufacture of microfluidic devices. In particular, the injection molded microfluidic devices require the fabrication of two or more separate molded parts that require stacking and sealing by clamping and/or welding. Alternatively, the injection molded microfluidic article, containing the microfluidics channels, may be sealed off by applying a tape on the half open channels.

European Patent Application No. 13160987.7 (published as EP2653285, and hereinafter referred to as “EP2653285”) described the use of hesitation to injection mold a microfluidic device. Typically, hesitation is an unwanted effect occurring during injection molding processes that results molding defects. EP2653285 describes the use of hesitation to create structures with closed and sealed microchannels. The described method may potentially increase production speed since the sealing and clamping or welding steps, which are typically associated with injection molding of microfluidic devices, are not required. The method described in EP2653285 may be limited with regard to the maximum channel width, e.g., if the aspect ratio between the channel width and the base layer thickness is too small, the microchannel may become filled instead of simply sealed.

Currently, no injection molding method has been described that allows manufacture of a microfluidic device on a single injection molding machine without the need for secondary operations to provide a device ready for use.

These and other shortcomings are addressed by aspects of the present disclosure.

### SUMMARY OF THE DISCLOSURE

As described in more detail herein, the present disclosure provides methods, apparatuses, and systems pertaining to devices such as microfluidic devices, for example.

In an aspect, the disclosure relates to methods of making a microfluidic device using hesitation during injection molding may comprise molding a base layer having a microchannel (or micro-slit) formed therein; disposing a planar barrier adjacent to a surface of the base layer and positioned to overlay at least a portion of the microchannel; and causing a material to be disposed on the base layer using hesitation injection molding to create a closing layer configured to overmold at least a portion of the planar barrier and a least a portion of the microchannel, wherein the planar barrier reduces an ingress of the material into the microchannel as compared to a substantially similar base layer and microchannel without the planar barrier. The disclosed method may further comprise forming one or more of an inlet and an outlet in the closing layer. The method may also further comprise overmolding a cover layer on the base layer; and wherein the cover layer is formed on the base layer on a surface thereof that is opposite the base layer surface comprising the planar barrier.

In another aspect, the disclosure relates to methods of making a microfluidic device using hesitation injection molding, the method comprising: molding a base layer having a microchannel formed therein; disposing a sensor adjacent a first surface of the base layer; molding a cover layer adjacent the first surface of the base layer to at least partially cover the sensor and to secure the sensor in position relative to the base layer; and molding a closing layer on a second surface of the base layer opposite the first surface of the base layer, wherein the closing layer encloses at least a portion of the microchannel

In an aspect, the disclosure relates to methods using a diagnostic device having a hesitation injection molded closing layer configured to enclose at least a portion of a microchannel, a barrier layer, and a diagnostic device, the method comprising: causing a fluid to pass through the microchannel, wherein the fluid is caused to interface with the diagnostic device; and receiving information from the diagnostic device relating to a characteristic of the fluid.

### BRIEF DESCRIPTION OF THE FIGURES

The accompanying figures, which are incorporated in and constitute a part of this specification, illustrate several aspects and together with the description serve to explain the principles of the disclosure.

FIG. 1 shows a schematic representation of the problem of filling the microchannel if the aspect ratio between channel width and thickness of base layer is too small.

FIG. 2 shows a schematic representation of a disclosed method of overcoming the problem shown in FIG. 1.

FIG. 3 shows a schematic representation of a cross-section of a microfluidic device comprising a closing layer, comprising inlet and outlet ports, and a closing layer, comprising a sensor. As shown, the closing layer closes off the half open microchannels in the base layer.

FIG. 4 shows a schematic representation of a disclosed method of overcoming the problem shown in FIG. 1 and where the base layer has two microchannels.

FIG. 5 shows a schematic representation of the process in a single three cavity or station mold with integrated turn table.

FIG. 6 shows a schematic representation of a microfluidic device with three valves incorporated into the cover layer.

FIG. 7 shows a representative photomicrograph of a triangular shaped opening with a 200 micrometer (micron, μm) microchannel at the apex of the opening in which injection was carried out in a flow direction perpendicular to the orientation of the opening at the indicated packing pressures.

FIG. 8 shows a representative photomicrograph of a triangular shaped opening with a 200 μm microchannel at the apex of the opening in which injection was carried out in a flow direction parallel to the orientation of the opening at the indicated packing pressures.

FIGS. 9A-9C show representative cross-sectional geometries of molded openings in a base layer in which a channel is molded at the apex region or deepest portion of the opening FIG. 9A shows a square opening molded in the base layer. FIG. 9B shows a triangular opening molded in the base layer with a microchannel molded at the apex region of the triangular opening. FIG. 9C shows a semi-circular opening molded in the base layer with a microchannel molded at the apex region of the triangular opening.

Additional advantages of the disclosure will be set forth in part in the description which follows, and in part will be apparent from the description, or may be learned by practice of the disclosure. The advantages of the disclosure will be realized and attained by means of the elements and combinations particularly pointed out in the appended claims. It is to be understood that both the foregoing general description and the following detailed description are exemplary and explanatory only and are not restrictive of the disclosure, as claimed.

### DETAILED DESCRIPTION

The present disclosure may be understood more readily by reference to the following detailed description of the disclosure and the Examples included therein.

It is to be understood that the terminology used herein is for the purpose of describing particular aspects only and is not intended to be limiting. As used in the specification and in the claims, the term “comprising” may include the embodiments “consisting of and “consisting essentially of” Unless defined otherwise, all technical and scientific terms used herein have the same meaning as commonly understood by one of ordinary skill in the art to which this disclosure belongs. In this specification and in the claims which follow, reference will be made to a number of terms which shall be defined herein.

Before the present compounds, compositions, articles, systems, devices, and/or methods are disclosed and described, it is to be understood that they are not limited to specific synthetic methods unless otherwise specified, or to particular reagents unless otherwise specified, as such may, of course, vary. It is also to be understood that the terminology used herein is for the purpose of describing particular aspects only and is not intended to be limiting. Although any methods and materials similar or equivalent to those described herein may be used in the practice or testing of the present disclosure, example methods and materials are now described.

Moreover, it is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of aspects described in the specification.

Throughout this application, various publications are referenced. The disclosures of these publications in their entireties are hereby incorporated by reference into this application in order to more fully describe the state of the art to which this pertains. The references disclosed are also individually and specifically incorporated by reference herein for the material contained in them that is discussed in the sentence in which the reference is relied upon. Nothing herein is to be construed as an admission that the present disclosure is not entitled to antedate such publication by virtue of prior disclosure. Further, the dates of publication provided herein may be different from the actual publication dates, which may require independent confirmation.

As used in the specification and the appended claims, the singular forms “a,” “an” and “the” include plural referents unless the context clearly dictates otherwise. Thus, for example, reference to “a ketone” includes mixtures of two or more ketones.

Ranges may be expressed herein as from one particular value to another particular value. When such a range is expressed, another aspect includes from the one particular value and/or to the other particular value. Similarly, when values are expressed as approximations, by use of the antecedent ‘about,’ it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “about” and “at or about” mean that the amount or value in question can be the value designated some other value approximately or about the same. It is generally understood, as used herein, that it is the nominal value indicated±5% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but maybe approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

As used herein, the terms “optional” or “optionally” means that the subsequently described event or circumstance mayor cannot occur, and that the description includes instances where said event or circumstance occurs and instances where it does not. For example, the phrase “optional gripper” means that the gripper can or cannot be included and that the description includes aspects that both include and do not include a gripper.

As used herein, the term “combination” is inclusive of blends, mixtures, alloys, reaction products, and the like.

Disclosed are the components to be used to prepare the compositions of the disclosure as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds cannot be explicitly disclosed, each is specifically contemplated and described herein. For example, if a particular compound is disclosed and discussed and a number of modifications that may be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the disclosure. Thus, if there are a variety of additional steps that can be performed it is understood that each of these additional steps can be performed with any specific aspect or combination of aspects of the methods of the disclosure.

References in the specification and concluding claims to parts by weight, of a particular element or component in a composition or article, denotes the weight relationship between the element or component and any other elements or components in the composition or article for which a part by weight is expressed. Thus, in a compound containing 2 parts by weight of component X and 5 parts by weight component Y, X and Y are present at a weight ratio of 2:5, and are present in such ratio regardless of whether additional components are contained in the compound.

A weight percent (wt. %) of a component, unless specifically stated to the contrary, is based on the total weight of the formulation or composition in which the component is included. For example if a particular element or component in a composition or article is said to have 8% weight, it is understood that this percentage is relation to a total compositional percentage of 100%.

Each of the materials disclosed herein are either commercially available and/or the methods for the production thereof are known to those of skill in the art.

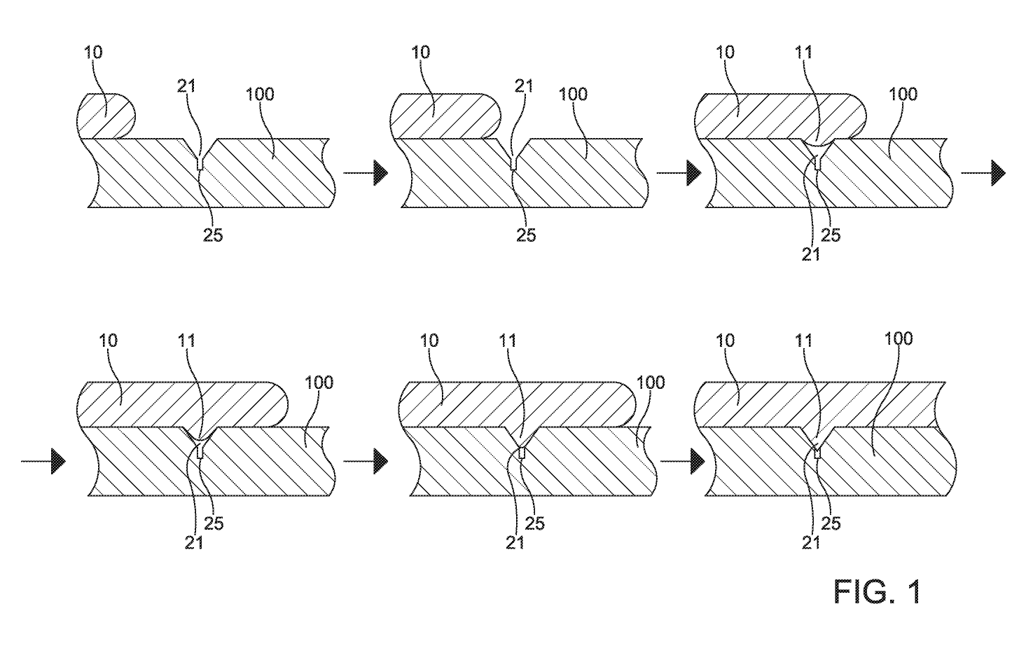

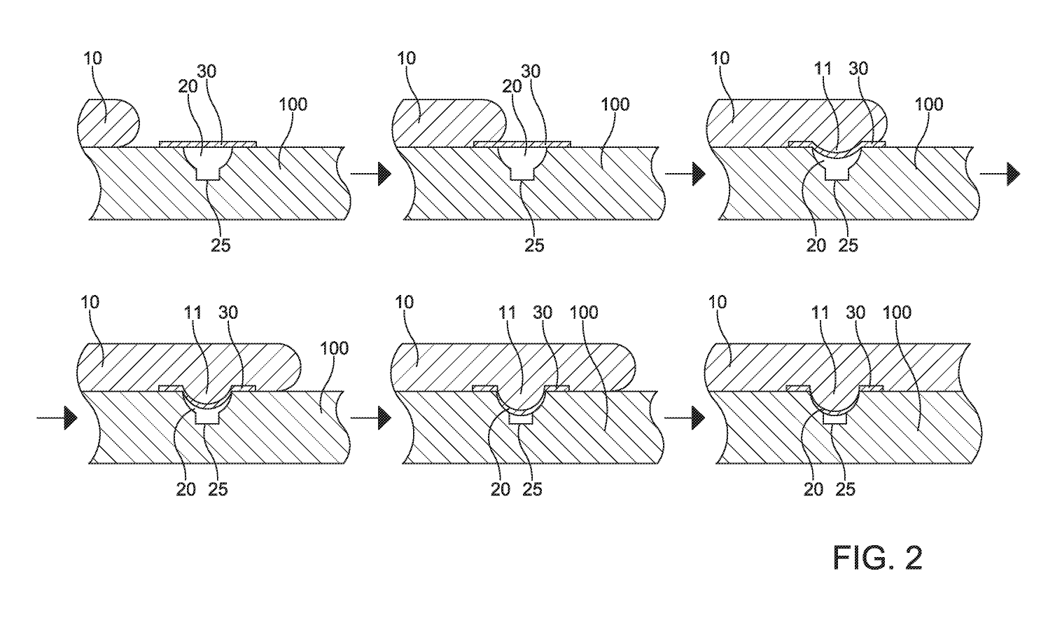

As used herein, hesitation is the local slow down, or complete stop, of flow filling in a cavity with a thick and thin section. When given a choice by creating parallel flow paths, a polymer melt flows along the route with the lowest resistance and therefore tends to fill the thick section first, e.g., see FIGS. 1 and 2. This may result in plastic in the thin section stopping or slowing significantly. Once the plastic starts to slow down, the plastic will cool more rapidly, thereby increasing viscosity. This higher viscosity will inhibit flow further causing even faster cooling so that the problem of stopping and slowing becomes self-propagating. Thus, the polymer at the entrance of the thin cavity part is given time to cool, to raise viscosity and ultimately to “freeze-in.” As the flow encounters a thin cavity part, such as opening 20, a freeze-in 11 occurs. As known to one skilled in the art, when hesitation is not desired and leads to molding defect, the problem may be overcome by placing the thin cavities at the ends or edges of the mold.

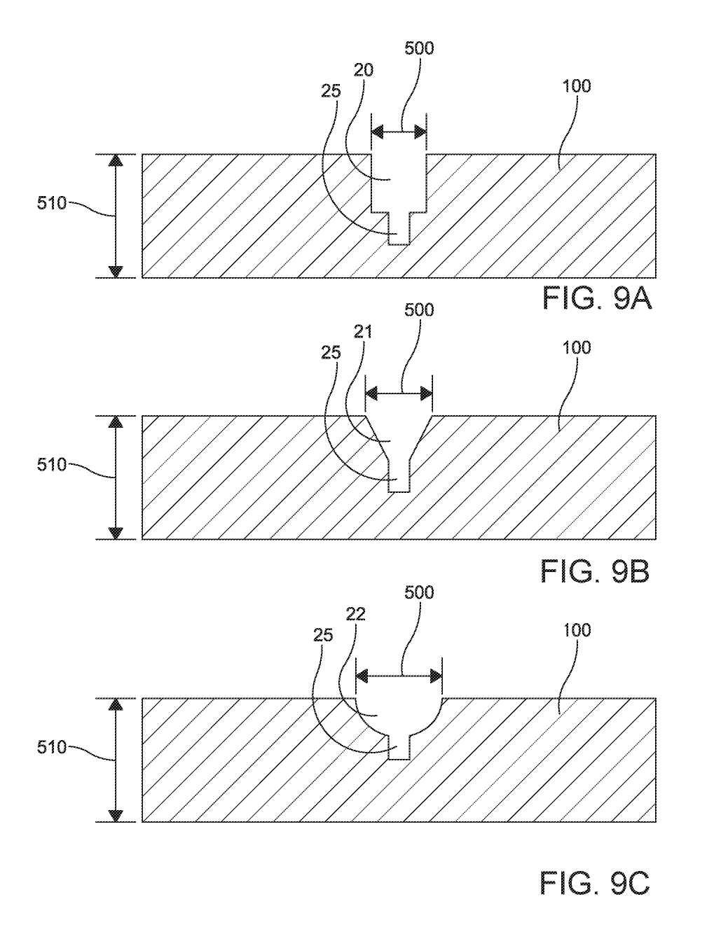

As used herein, “hesitation injection molding” refers to the advantageous use of hesitation during injection molding. In particular, as used herein, a base layer comprising one or more microchannels is overmolded with a closing layer using injection molding techniques, and during injection molding of the closing layer, hesitation in proximity to the microchannels results in open or half-open microchannels beneath the closing layer. For example, a base layer is molded comprising one or more molded slots, e.g., see 20, 21, and 22 in FIGS. 9A-9C, respectively, wherein at the bottom of the molded slot is molded a microchannel, e.g., see 25 in FIGS. 9A-9C. The base layer is overmolded to form a closing layer, e.g., see FIG. 1, and hesitation during the molding process of the closing layer can partially fill a molded slot, but leave the microchannel open.

As used herein, “microfluidic device” refers to a device comprising at least one inlet and outlet which are connected to each other via a microchannel. The microfluidic device can further comprise a microchamber for constant chemical reaction or analysis. The microchannel can have various shapes of cross-section, for example, circular, rectangular, semi-circular or trapezoid cross-section, but is not limited thereto. The microfluidic device can further comprise a sensor in contact with one or more microchannels and/or a microchamber. A lab-on-a-chip or LOC is a type of microfluidic device.

As used herein, the term “off-chip” refers to structures, modules, and other components that may be integrated with or connected to, but do not form part of, the microfluidic device, as well as the handling or processing of reagents off or outside of a microfluidic device.

As used herein, the term “upstream” refers to components are modules in the direction opposite the flow of fluids from a given reference point in a microfluidic device.

As used herein, the term “downstream” refers to components or modules in the direction of the flow of fluids from a given reference point in a microfluidic device.

Unless otherwise stated to the contrary herein, all test standards are the most recent standard in effect at the time of filing this application.

It is understood that the compositions disclosed herein have certain functions. Disclosed herein are certain structural requirements for performing the disclosed functions, and it is understood that there are a variety of structures that may perform the same function that are related to the disclosed structures, and that these structures will typically achieve the same result.

In an aspect, the disclosure relates to methods of making a microfluidic device using hesitation injection molding may comprise molding a base layer having a microchannel formed therein; disposing a planar barrier adjacent to a surface of the base layer and positioned to overlay at least a portion of the microchannel; and causing a material to be disposed on the base layer using hesitation injection molding to create a closing layer configured to overmold at least a portion of the planar barrier and a least a portion of the microchannel, wherein the planar barrier reduces an ingress of the material into the microchannel as compared to a substantially similar base layer and microchannel without the planar barrier. The disclosed method may further comprise forming one or more of an inlet and an outlet in the closing layer. The method may also further comprise overmolding a cover layer on the base layer; and wherein the cover layer is formed on the base layer on a surface thereof that is opposite the base layer surface comprising the planar barrier.

A microfluidic device of the present disclosure may comprise inlets and outlets, or openings, which in turn may be connected to valves, tubes, channels, chambers, syringes and/or pumps for the introduction and extraction of fluids into and from the microfluidic device. A microfluidic device may further comprise off-chip structures, modules, and other components that may be integrated with or connected to, but do not form part of, the microfluidic device, as well as the handling or processing of reagents off or outside of a microfluidic device. The off-chip structures, modules, or other components can be upstream and/or downstream of the microfluidic device.

In another aspect, the disclosure relates to methods of making a microfluidic device using hesitation injection molding, the method comprising: molding a base layer having a microchannel formed therein; disposing a sensor adjacent a first surface of the base layer; molding a cover layer adjacent the first surface of the base layer to at least partially cover the sensor and to secure the sensor in position relative to the base layer; and molding a closing layer on a second surface of the base layer opposite the first surface of the base layer, wherein the closing layer encloses at least a portion of the microchannel

In an aspect, the disclosure relates to methods using a diagnostic device having a hesitation injection molded closing layer configured to enclose at least a portion of a microchannel, a barrier layer, and a diagnostic device, the method comprising: causing a fluid to pass through the microchannel, wherein the fluid is caused to interface with the diagnostic device; and receiving information from the diagnostic device relating to a characteristic of the fluid.

In an aspect, the disclosure concerns increasing the maximum width of a microchannel formed by hesitation injection molding by applying a film in between the base layer containing an opening to provoke hesitation and on top of this opening a half open microchannel Although hesitation injection molding may be used for forming a closing layer 110, on a base layer 100, to form a seal on an opening or microchannel (e.g., the opening 20). However, there are situations, e.g., when a wide channel is desired wherein the aspect ratio between channel width and thickness of base layer is too small, when the closing layer fills or nearly fills a microchannel or opening in the base layer. Accordingly, the closing layer occludes or blocks the desired microchannel rather than merely forming a sealed or closure over the microchannel in the base layer. A schematic representation of the problem of filling the microchannel if the aspect ratio between channel width and thickness of base layer is too small is shown in FIG. 1. The process of using hesitation to create a microchannel with relative low aspect ratio between closing layer and microchannel width is schematically shown in FIG. 1. In the schematic representation shown in FIG. 1, each image shows a snapshot of the flow of a material such as a polymer melt 10, which may be flowing across a surface of the base layer 100, containing at least one molded slot 20, (or 21, 22 in subsequent figures) with a molded microchannel 25, molded therein. Although reference is made to a polymeric flow (e.g., polymer melt 10), other materials and material deposition techniques may be used in a similar fashion.

In some aspects, the polymer includes, but is not limited to, a cyclic olefin copolymer, a polycarbonate, a poly(methyl methacrylate), a polystyrene or a combination thereof.

Conventionally, when the polymer melt 10 encounters the opening of a small molded slot 21 (or slot 20 or slot 22, depending upon the geometry of the molded slot), hesitation of the flow of the polymer melt 10 into a molded slot 21 occurs and a localized freeze in 11, results. The flow rate of the polymer melt 10 at the freeze in 11 starts to slow down and the polymer melt 10 begins to cool more rapidly, thereby increasing the viscosity. Thus, by time the flow of the polymer melt 10 is complete and the closing layer 110, is fully formed, the molded slot 21, is partially filled. However, if the ratio of the width of the opening of molded slot 21 to the thickness of the base layer 100 is too small, then the molded slot 21 may be nearly completely filled.

In an aspect, the present disclosure provides a facile and surprising solution to the problem of hesitation in injection molding when wide channels, i.e., low aspect ratio microchannels, are desirable in the base layer 100. A low aspect ratio may be a ratio of the thickness of the closing layer to the width of the microchannel that is 4 or about 4 or less than 4. The solution comprises placing a barrier 30 (e.g., a composite tape) over the microchannel with the low aspect ratio, which is schematically shown in FIG. 2. The barrier 30, comprising a composite tape, for example, may comprise a polymer film, steel, ceramic, or glass composite, or a combination thereof, containing fibers and may have a thickness, for example, of about 0.125 millimeters (mm). As shown, the polymer melt 10, flows across a surface of the base layer 100 containing one or more of the molded slots 20, with a low aspect ratio therein. The barrier 30 may be placed upon the opening 20 such that the barrier 30 covers at least a portion of the molded slot 20 and extends to the surrounding surface of the base layer 100. In certain aspects, at least a portion of the barrier 30 may be configured to adhere to the base layer 100 and thereby form a seal over the molded slot 20. Thus, as the polymer melt 10 encounters the region comprising the molded slot 20, which is covered by the barrier 30, rather than enter the molded slot 20, the polymer melt 10, flows across a surface of the barrier 30 with minimal or no hesitation. In some aspects, as the polymer melt 10 encounters the barrier 30, there may be some deformation of the barrier 30 into the molded slot 20, as shown in FIG. 2. The degree of deformation of the barrier 30 may depend upon a variety of variables such as temperature of the polymer melt 10, adherence of the barrier 30 to the base layer 100, and thickness or composition of the barrier 30. The skilled artisan may choose the appropriate barrier 30 based upon a consideration of these variables. The use of the barrier 30 to seal at least a portion of the molded slot 20 to flow of polymer melt 10 allows the molding of channels such as microchannels in the base layer 100 with very low aspect ratios.

The base layer 100 may have a thickness of about 500 micrometers (microns, μm) to about 2000 μm, or from 500 μm to 2000 μm. In an aspect, the base layer 100, may have a thickness of about 800 μm, about 900 μm, about 1000 μm, about 1100 μm, or about 1200 μm, or a thickness of 800 μm, 900 μm, 1000 μm, 1100 μm, or 1200 μm. In a further aspect, the base layer, 100, may have a thickness of 1000 μm, or about 1000 μm.

The width of a microchannel, e.g., 25, may be 100 μm to 1000 μm, about 100 μm to about 1000 μm, or from 500 μm to 1000 μm, or about 500 μm to about 1000 μm, from 800 μm to 1000 μm or from about 800 μm to about 1000 μm. It is understood that intervening end points are included in the described ranges. In an aspect, the width of a microchannel, e.g., opening of 25, may be about 100 μm, about 200 μm, about 300 μm, about 400 μm, or about 500 μm. In further aspects, the width of a microchannel may be 100 μm, 200 μm, 300 μm, 400 μm, or 500 μm.

The aspect ratio of the thickness of the base layer 100 to a width of a molded slot or a microchannel, e.g., opening 20, 21, 22, or 25, may be 0.5 to 2.0, or about 0.5 to 2.0. In an aspect, the aspect ratio of the thickness of the base layer 100 to a width of a molded slot or a microchannel, e.g., opening 20, 21, 22, or 25, may be 1.8, 1.9, 2.0, 2.1, 2.2, about 1.8, about 1.9, about 2.0, about 2.1, or about 2.2.

The closing layer 110 may have a thickness of 500 μm to 2000 μm or about 500 μm to about 2000 μm. In an aspect, the closing layer 110 may have a thickness of 800 μm, 900 μm, 1000 μm, 1100 μm, 1200 μm, about 800 μm, about 900 μm, about 1000 μm, about 1100 μm, or about 1200 μm. In a further aspect, the closing layer 110 may have a thickness of 1000 μm or about 1000 μm.

The ratio of the thickness of the closing layer 100 to a width of a molded slot or a microchannel, e.g., opening 20, 21, 22, or 25, may be 2 to 20 or about 2 to about 20, or 2 to 10, or about 2 to about 10. In further examples, the ratio of the thickness of the closing layer 100 to a width of a molded slot or a microchannel, e.g., opening 20, 21, 22, or 25, may be 2 to 40 or about 2 to about 40. In an aspect, the aspect ratio of the thickness of the base layer 100 to a width of a microchannel, e.g., opening 20, 21, 22, or 25, may be from 4 to 15 or about 4 to about 15, for example 5, 6, 7, 8, 9, 10, 11, 12, 13, 14, 15, about 5, about 6, about 7, about 8, about 9, about 10, about 11, about 12, about 13, about 14, or about 15. In certain aspects the ratio of the thickness of the closing layer 100 to a width of a molded slot or a microchannel, e.g., opening 20, 21, 22, or 25, may be greater than 40 or greater than about 40.

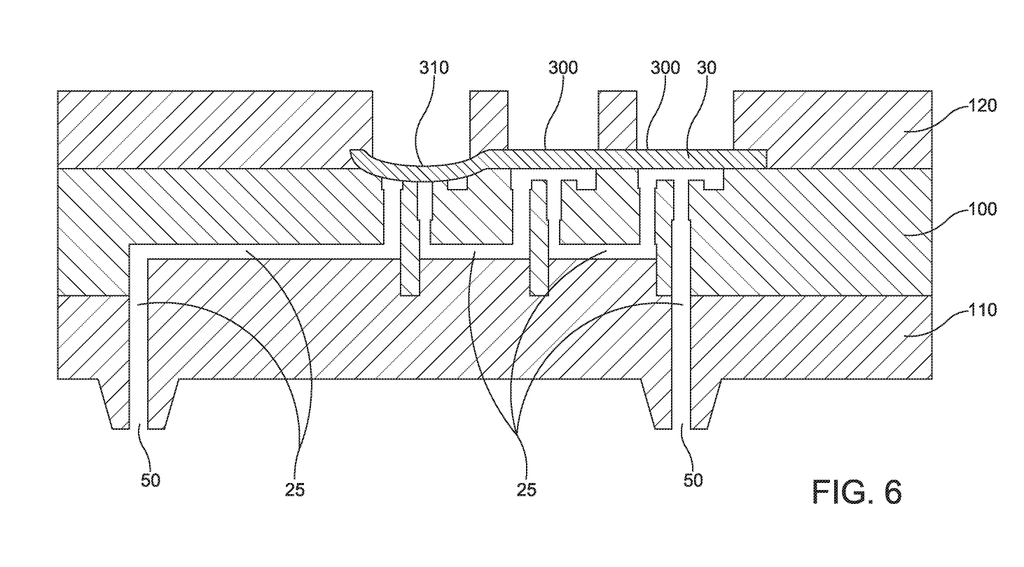

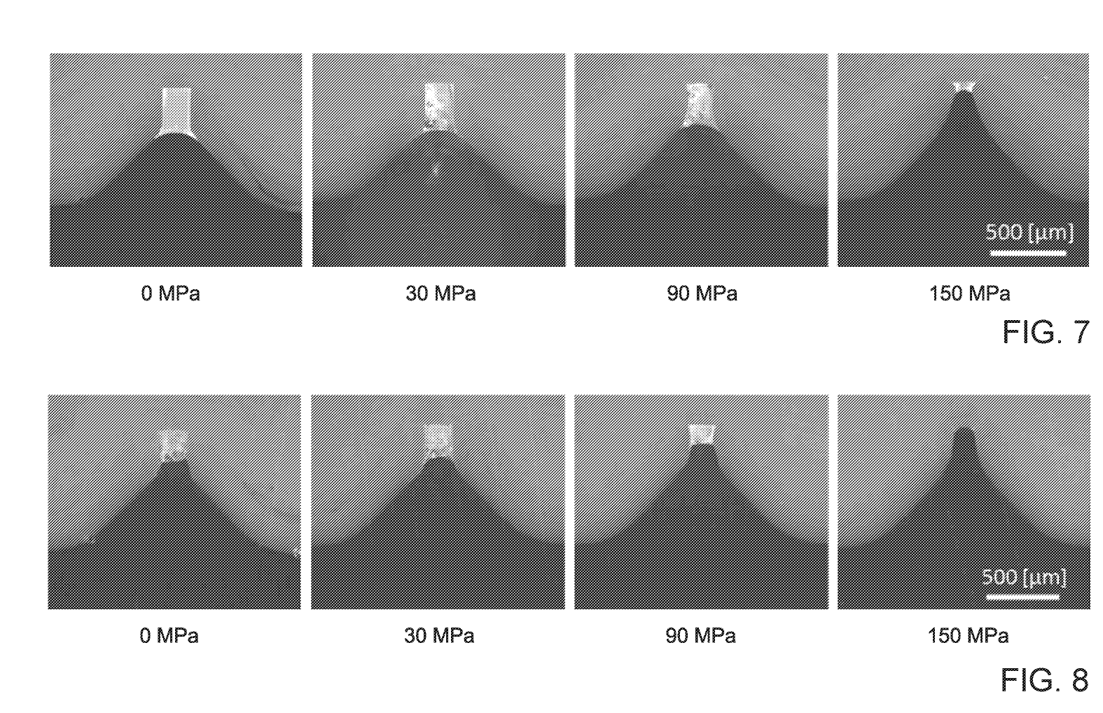

In an aspect, an opening or microchannel molded in a base layer may have different cross-sectional geometries. For example, as shown in FIG. 9A (and also shown in FIGS. 1 and 2), a simple opening 20 or microchannel may be molded in the base layer 100, which may be filled to varying amounts with the closing layer 110 overmold. Alternatively, as shown in FIG. 9B (and also shown in FIGS. 6 and 7), a triangle channel 21, may be molded in the base layer 100, with a microchannel 25 formed at the apex of the triangular channel 21. In some aspects, it may be desirable to mold a semi-circular or rounded channel 22 in the base layer 100 with a microchannel 25 molded at the deepest portion of the semi-circular or rounded channel 22. A tape overlay such as a barrier (e.g., barrier 30) may be required during the overmolding of the closing layer 110 if the aspect ratio of the width 500 of the opening or microchannel to the depth 510 is low, e.g., less than about two. However, under certain conditions a barrier is not required to maintain a volume of opening within the channel to allow fluid to flow therethrough. In certain aspect, it is beneficial to maintain 30%, 40%, 50%, 60%, 70%, 80%, 90% or intervening percentages of the total volume of the channel after overmolding the closing layer 110 over a channel In further examples, the microchannel 25 may be directly at a surface of the base layer100 without a microchannel 20 of any geometry.

In an aspect, a material may be disposed on a base layer using hesitation injection molding to create a closing layer configured to overmold at least a portion of a planar barrier and a least a portion of the microchannel, wherein the planar barrier reduces an ingress of the material into the microchannel as compared to a substantially similar base layer and microchannel without the planar barrier. A substantially similar base layer and microchannel may refer to a substantially similar base layer and microchannel having the same dimensions (such as, for example, height or depth, width, and aspect ratios) in the absence of a planer barrier.

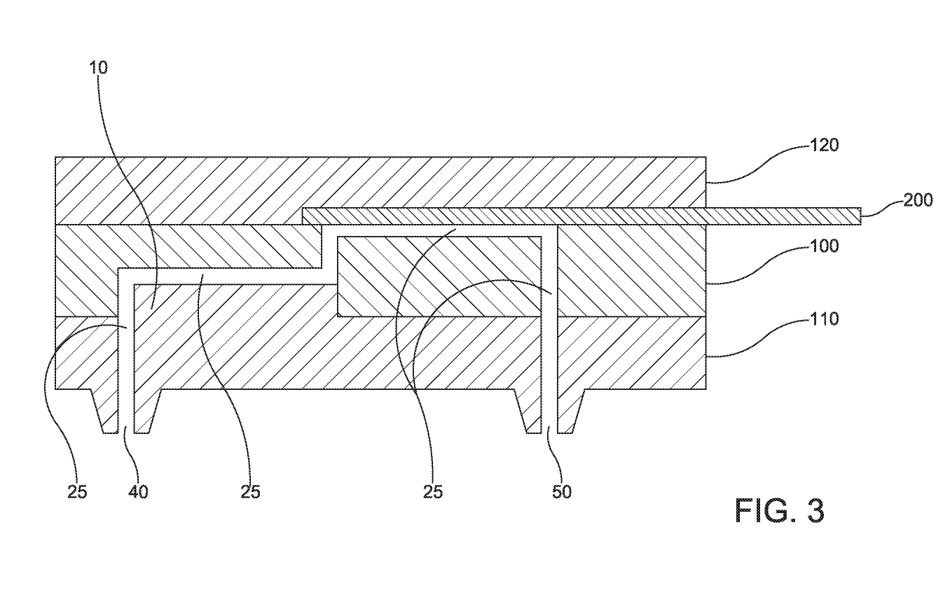

In an aspect, the disclosure concerns microfluidic devices comprising a base layer, 100, overmolded with a closing layer 110, and cover layer 120, which may comprises or overmold a sensor 200. A schematic diagram showing a cross-sectional view of an exemplary device with these aspects is shown in FIG. 3. As shown, the cross-sectional view shows the closing layer closing off the half open microchannels in the base layer. Also shown are inlet 40 and outlet 50 ports that are incorporated in the closing layer 110. A sensor 200 is shown along the top of the base layer 100 in contact with a microchannel or opening 20. In the manufacturing process, the sensor 200 may be disposed with a microchannel (e.g., configured to receive a fluid flow passing through the microchannel), followed by overmolding the cover layer 120 to secure the sensor 200 in position. The sequence of overmolding of the closing layer, 110, and the cover layer, 120, may be interchanged as desired by the skilled artisan. Alternatively, overmolding of 110 and 120 may occur simultaneously. Following overmolding of the closing layer 110 and the cover layer 120, a single piece fully incorporated microfluidic device comprising the sensor 200, is provided. Other channels, vessels, pockets, orifices, devices, and features may be formed, covered, or closed off using the processes described herein. Various channel formations have various sizes and shapes may be defined using similar techniques as those described herein in reference to the microchannel 20, as well as, the base layer 100, cover layer 120, and closing layers 110.

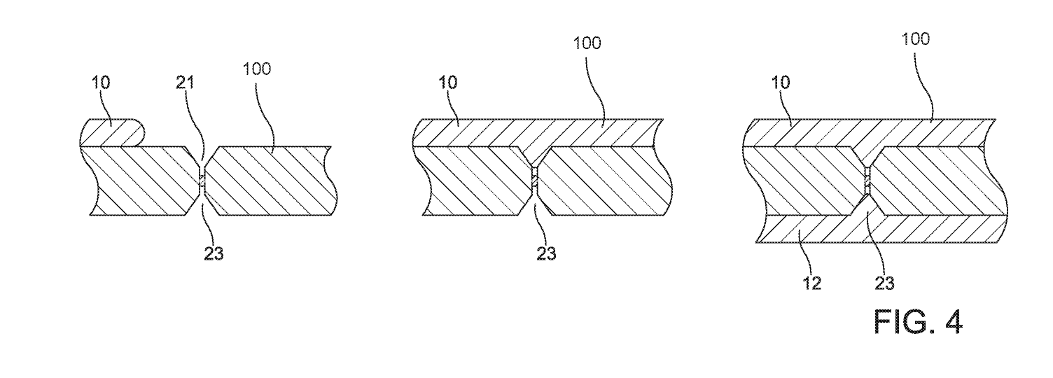

In certain aspects, as presented in FIG. 4, the base layer may comprise microchannels within one or more surfaces of the base layer. A polymer melt 10, may flow across a surface of the base layer 100 containing first and second molded slots 21, 23 with a low aspect ratio therein. A second polymer melt 12 may flow across a second surface of the barrier layer to the second molded slot 23.

In an aspect, the disclosure relates to a method for manufacturing of a three layered microfluidic device, wherein the method of manufacturing comprises a single mold comprising a turntable with three cavities or stations. Briefly, the method may comprise using a three platens mold, comprising three different cavity geometries in the fixed mold halve and a moving mold half. The middle section of the mold may be used to transfer the semi-finished product to the next cavity. In the first cavity or station the base layer with the half open microchannel is molded. After mold opening, a turntable transfers the base layer to the second station or cavity. Prior to mold closing a sensor is placed on top of the base layer, and kept in place using gripper, comprising a gripping means. Following mold closing, the cover layer is molded and thereby fixes the sensor in place. Positioning of the sensor either be via manual position of the mold, or via an automated positioning means. Following molding the cover layer, the mold opens again and the partially finished product is transported to the third and last cavity or station of the process. In the third step, the closing layer is injection molded on the opposite side of the base layer. As required, e.g., a low aspect ratio between microchannel width and thickness of closing layer, a tape may be placed on top of the opening in the base layer. The mold then closes and the closing layer is injection molded on top of the base layer. The order of molding of the cover layer and closing layer may also be interchanged.

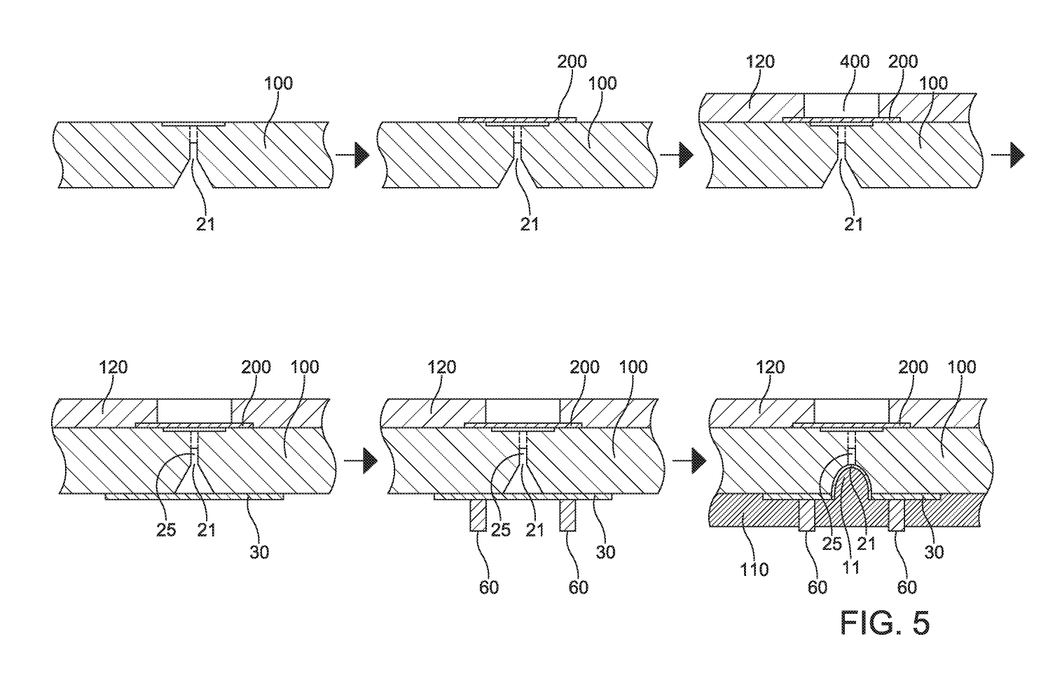

The method for manufacturing of a three layered microfluidic device, wherein the method of manufacturing comprises a single mold comprising a turntable with three cavities or stations, is showing schematically in FIG. 5. Each image shown in FIG. 4 shows a snapshot in the sequence of events in method for manufacturing a three layered microfluidic device. In Step 1, injection molding is carried out to provide the base layer 100, with a half open molded slot 21 having a triangular cross-section and with a half-open microchannel, 25. In Step 2, the sensor 200 is positioned on a surface of the base layer 100 in contact with one or more molded slots 21. In Step 3, injection molding is used to overmold the sensor 200 and form the cover layer 120 on top of the base layer 100. As shown, the overmolding process has formed a cover layer chamber 400, within the cover layer 120 that provides access to the sensor 200. The cover layer chamber 400, provides access to the sensor 200 to allow adjustments or visual inspection. In addition, the cover layer chamber 400 also permits thermal management of the sensor 200 environment, e.g., a thermal control medium such as a gas or liquid of a defined temperature can be introduced into the cover layer chamber 400 to provide control of the sensor 200 temperature. As required by the particular use of the microfluidic device, the thermal control medium in the cover layer chamber 400, can be changed as a function of time to allow for controlled temperature changes in the sensor environment as a function of time. Another advantage of the cover layer chamber 400 is to facilitate management of deformation without damage to the sensor 200 if there unintended pressure spikes or over flow in the microchannel(s) in contact with the sensor 200. Steps 4 and 5 are optional and depend upon the aspect ratio between the molded slot 21 width and closing layer 110 thickness. In Step 4, a barrier 30, such as planar tape, is positioned to cover the one or more half open microchannel 21, as shown. In Step 5, a gripper 60 comprising a gripping means, may be optionally positioned in contact with the barrier 30 to maintain the barrier 30 in place during overmolding. In Step 6, injection molding is used to overmold the closing layer 110 on the base layer 100, as shown, with the microchannel 25 maintained in an open state. As required, an inlet and/or outlet port may be formed during the overmolding of the closing layer 110. In further examples, the inlet and/or outlet port may be disposed within the cover layer.

In an aspect, the disclosure relates to a microfluidic device comprising a valve formed from a barrier 30 such as a planar material (e.g., tape, baffle, wall or plate). That is, the use of the barrier 30 to close/cover a microchannel or opening has further utility to that already described herein above. As already described herein, the barrier 30 used in the disclosed methods may vary in thickness and/or composition. For example, in order to form a valve using barrier 30, a selection criterion is that the tape, baffle, wall, or plate be flexible. FIG. 6 shows a microfluidic device with three valves formed from the barrier 30. As shown, a positive inward pressure 310 applied to the barrier 30 actuates the valve to close it by causing the flexible material to move inwardly and close against the microchannels, as shown. In contrast, in the absence of a positive inward pressure, the flexible material forming the barrier 30 is not deflected inwardly, and the valve remains open 300. Various material properties and pressures may be configured to restrict and/or facilitate controlled flow of fluid through the microchannel

### Aspects

The disclosed systems and methods include at least the following aspects.

Aspect 1. A method of making a microfluidic device using hesitation injection molding, the method comprising: molding a base layer having a microchannel formed therein; disposing a planar barrier adjacent to a surface of the base layer and positioned to overlay at least a portion of the microchannel; and causing a material to be disposed on the base layer using hesitation injection molding to create a closing layer configured to overmold at least a portion of the planar barrier and a least a portion of the microchannel, wherein the planar barrier reduces an ingress of the material into the microchannel as compared to a substantially similar base layer and microchannel without the planar barrier.

Aspect 2. A method of making a microfluidic device using hesitation injection molding, the method consisting essentially of: molding a base layer having a microchannel formed therein; disposing a planar barrier adjacent to a surface of the base layer and positioned to overlay at least a portion of the microchannel; and causing a material to be disposed on the base layer using hesitation injection molding to create a closing layer configured to overmold at least a portion of the planar barrier and a least a portion of the microchannel, wherein the planar barrier reduces an ingress of the material into the microchannel as compared to a substantially similar base layer and microchannel without the planar barrier.

Aspect 3. A method of making a microfluidic device using hesitation injection molding, the method consisting of: molding a base layer having a microchannel formed therein; disposing a planar barrier adjacent to a surface of the base layer and positioned to overlay at least a portion of the microchannel; and causing a material to be disposed on the base layer using hesitation injection molding to create a closing layer configured to overmold at least a portion of the planar barrier and a least a portion of the microchannel, wherein the planar barrier reduces an ingress of the material into the microchannel as compared to a substantially similar base layer and microchannel without the planar barrier.

Aspect 4. The method of any of aspects 1-3, wherein an aspect ratio of a thickness of the base layer to a width of the microchannel is about 0.5 to about 2.5.

Aspect 5. The method of any of aspects 1-3, wherein an aspect ratio of a thickness of the base layer to a width of the microchannel is 0.5 to 2.5.

Aspect 6. The method of any of aspects 1-3, wherein an aspect ratio of a thickness of the base layer to a width of the microchannel is about 2.

Aspect 7. The method of any of aspects 1-3, wherein an aspect ratio of a thickness of the base layer to a width of the microchannel is 2.

Aspect 8. The method of any of aspects 1-7, wherein an aspect ratio of a thickness of the closing layer to a width of the microchannel is about 10 to about 40.

Aspect 9. The method of any of aspects 1-7, wherein an aspect ratio of a thickness of the closing layer to a width of the microchannel is 10 to 40.

Aspect 10. The method of any of aspects 1-7, wherein an aspect ratio of a thickness of the closing layer to a width of the microchannel is about 10 to about 20.

Aspect 11. The method of any of aspects 1-7, wherein an aspect ratio of a thickness of the closing layer to a width of the microchannel is 10 to 20.

Aspect 12. The method of any of aspects 1-7 wherein an aspect ratio of a thickness of the closing layer to a width of the microchannel is about 10.

Aspect 13. The method of any of aspects 1-7, wherein an aspect ratio of a thickness of the closing layer to a width of the microchannel is 10.

Aspect 14. The method of any of aspects 1-13, wherein the planar barrier comprises a tape.

Aspect 15. The method of aspect 14, wherein the microchannel has a width of about 1 μm to 500 μm.

Aspect 16. The method of aspect 14, wherein the microchannel has a width of about 1 μm to about 500 μm.

Aspect 17. The method of any of aspects 1-16, wherein the planar barrier does not comprise a tape.

Aspect 18. The method of aspect 17, wherein the microchannel has a width greater than 300 μm.

Aspect 19. The method of aspect 17, wherein the microchannel has a width greater than 400 μm.

Aspect 20. The method of aspect 17, wherein the microchannel has a width greater than 500 μm.

Aspect 21. The method of aspect 17, wherein the microchannel has a width between about 300 μm and about 400 μm.

Aspect 22. The method of aspect 17, wherein the microchannel has a width between 300 μm and 400 μm.

Aspect 23. The method of aspect 17, wherein the microchannel has a width of about 500 μm to about 1000 μm or of about 800 μm to about 1000 μm.

Aspect 24. The method of aspect 17, wherein the microchannel has a width of 500 μm to 1000 μm or of 800 μm to 1000 μm.

Aspect 25. The method of any of aspects 1-24, wherein the material comprises a polymer.

Aspect 26. The microfluidic device of aspect 25, wherein the polymer is a cyclic olefin copolymer, a polycarbonate, a poly(methyl methacrylate), a polystyrene or a combination thereof.

Aspect 27. The method of any of aspects 1-26, wherein the microchannel is capable of receiving a flow of fluid after the closing layer has been overmolded thereon.

Aspect 28. The method of any of aspects 1-27, further comprising forming one or more of an inlet and an outlet in the closing layer.

Aspect 29. The method of aspect 28, wherein the forming of the one or more of the inlet and the outlet is executed during the injection molding of the material.

Aspect 30. The method of any one of aspects 1-29, further comprising overmolding a cover layer on the base layer; and wherein the cover layer is formed on the base layer on a surface thereof that is opposite the base layer surface comprising the planar barrier.

Aspect 31. A method of making a microfluidic device using hesitation injection molding, the method comprising: molding a base layer having a microchannel formed therein; disposing a sensor adjacent a first surface of the base layer; molding a cover layer adjacent the first surface of the base layer to at least partially cover the sensor and to secure the sensor in position relative to the base layer; and molding a closing layer on a second surface of the base layer opposite the first surface of the base layer, wherein the closing layer encloses at least a portion of the microchannel

Aspect 32. The method of aspect 31, wherein an aspect ratio of a thickness of the base layer to a width of the microchannel is 0.5 to 2.5.

Aspect 33. The method of aspect 31, wherein an aspect ratio of a thickness of the base layer to a width of the microchannel is about 0.5 to about 2.5.

Aspect 34. The method of aspect 31, wherein an aspect ratio of a thickness of the base layer to a width of the microchannel is about 2.

Aspect 35. The method of aspect 31, wherein an aspect ratio of a thickness of the base layer to a width of the microchannel is 2.

Aspect 36. The method of any of aspects 31-35, further comprising disposing a planar barrier adjacent the second surface of the base layer and positioned to overlay at least a portion of the microchannel, wherein the planar barrier reduces an ingress of material into the microchannel during molding of the closing layer as compared to a substantially similar base layer and microchannel without the planar barrier.

Aspect 37. The method of any of aspects 31-36, wherein an aspect ratio of a thickness of the closing layer to a width of the microchannel is 10 to 20.

Aspect 38. The method of any of aspects 31-37, wherein an aspect ratio of a thickness of the closing layer to a width of the microchannel is about 10 to about 20.

Aspect 39. The method of any of aspects 31-38, wherein an aspect ratio of a thickness of the closing layer to a width of the microchannel is about 10.

Aspect 40. The method of any of aspects 31-39, wherein an aspect ratio of a thickness of the closing layer to a width of the microchannel is 10.

Aspect 41. The method of any of aspects 31-40, wherein the microchannel is capable of receiving a flow of fluid after the closing layer has been overmolded thereon.

Aspect 42. The method of any one of aspects 31-41, further comprising forming one or more of an inlet and an outlet in the closing layer and/or cover layer.

Aspect 43. The method of aspect 42, wherein the forming of the one or more of the inlet and the outlet is executed during the molding of the closing layer and/or cover layer.

Aspect 44. The method of aspect 42, wherein one or more of an inlet and an outlet is aligned with at least a portion of the microchannel to allow fluid to pass there between.

Aspect 45. A method of using a diagnostic device having a hesitation injection molded closing layer configured to enclose at least a portion of a microchannel, a barrier layer, and a diagnostic device, the method comprising: causing a fluid to pass through the microchannel, wherein the fluid is caused to interface with the diagnostic device; and receiving information from the diagnostic device relating to a characteristic of the fluid.

Aspect 46. The method of aspect 45, wherein the barrier layer is configured to reduce ingress of the closing layer into the microchannel as compared to a substantially similar base layer and microchannel without the barrier.

Aspect 47. The method of any of aspects 45-46, further comprising applying a force to the barrier layer to control the flow of the fluid in the microchannel

Aspect 48. The method of any of aspects 45-47, wherein the diagnostic device comprises a sensor.

Aspect 49. The method of any of aspects 1-7, wherein an aspect ratio of a thickness of the closing layer to a width of the microchannel is greater than 40.

Aspect 50. The method of any of aspects 1-7, wherein an aspect ratio of a thickness of the closing layer to a width of the microchannel is greater than about 40.

Aspect 51. The method of any of aspects 31-36, wherein an aspect ratio of a thickness of the closing layer to a width of the microchannel is greater than 40.

Aspect 52. The method of any of aspects 31-36, wherein an aspect ratio of a thickness of the closing layer to a width of the microchannel is greater than about 40.

### EXAMPLES

Detailed aspects of the present disclosure are disclosed herein; it is to be understood that the disclosed aspects are merely exemplary of the disclosure that may be embodied in various forms. Therefore, specific structural and functional details disclosed herein are not to be interpreted as limits, but merely as a basis for teaching one skilled in the art to employ the present disclosure. The specific examples below will enable the disclosure to be better understood. However, they are given merely by way of guidance and do not imply any limitation.

Initial trials were performed in forming microchannels under a overmolded surface in the absence of a tape overlay for microchannels with a triangular opening geometry and a relatively high aspect ratio between microchannel width and closing layer thickness. The microchannel is show at the top of the figure (see FIGS. 7 and 8). FIG. 7 shows the results of these trials with the indicated packing pressure and an injection orientation perpendicular to the orientation of the opening, whereas FIG. 8 shows the results of these trials with the indicated packing pressure and an injection orientation parallel to the orientation of the opening. In these trials, at packing pressures to 90 megapascals (MPa), the microchannels remain open, i.e., less than 50% filled, for both perpendicular and parallel flow with respect to the microchannel orientation. Evaluation of parallel injection showed that using a triangular geometry is beneficial compared to a semi-circular opening; a larger volume of the microchannel remains open under higher packing pressures.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

1. A method of making a microfluidic device using hesitation injection molding, the method comprising:
molding a base layer having a microchannel formed therein;
disposing a planar barrier adjacent to a surface of the base layer and positioned to overlay at least a portion of the microchannel; and
causing a material to be disposed on the base layer using hesitation injection molding to create a closing layer configured to overmold at least a portion of the planar barrier and a least a portion of the microchannel, wherein the planar barrier reduces an ingress of the material into the microchannel as compared to a substantially similar base layer and microchannel without the planar barrier.

2. The method of claim 1, wherein an aspect ratio of a thickness of the base layer to a width of the microchannel is about 0.5 to about 2.5.

3. The method of claim 2, wherein the aspect ratio of a thickness of the base layer to a width of the microchannel is about 2.

4. The method of claim 1, wherein an aspect ratio of a thickness of the closing layer to a width of the microchannel is about 10 to about 40.

5. The method of claim 4, wherein the aspect ratio of a thickness of the closing layer to a width of the microchannel is about 10.

6. The method of claim 1, wherein the planar barrier does not comprise a tape.

7. The method of claim 6, wherein the microchannel has a width of about 1 μm to about 500 μm.

8. The method of claim 1, wherein the planar barrier comprises a tape.

9. The method of claim 8, wherein the microchannel has a width greater than about 500 μm.

10. The method of claim 8, wherein the microchannel has a width of about 500 μm to about 1000 μm or of about 800 μm to about 1000 μm.

11. The method of claim 1, wherein the material comprises a polymer.

12. The microfluidic device of claim 11, wherein the polymer is a cyclic olefin copolymer, a polycarbonate, a poly(methyl methacrylate), a polystyrene, or a combination thereof.

13. The method of claim 1, wherein the microchannel is capable of receiving a flow of fluid after the closing layer has been overmolded thereon.

14. The method of claim 1, further comprising forming one or more of an inlet and an outlet in the closing layer.

15. The method of claim 14, wherein the forming of the one or more of the inlet and the outlet is executed during the injection molding of the material.

16. The method of claim 1, further comprising overmolding a cover layer on the base layer; and wherein the cover layer is formed on the base layer on a surface thereof that is opposite the base layer surface comprising the planar barrier.

17. A method of making a microfluidic device using hesitation injection molding, the method comprising:
molding a base layer having a microchannel formed therein;
disposing a sensor adjacent a first surface of the base layer;
molding a cover layer adjacent the first surface of the base layer to at least partially cover the sensor and to secure the sensor in position relative to the base layer; and
molding a closing layer on a second surface of the base layer opposite the first surface of the base layer, wherein the closing layer encloses at least a portion of the microchannel.

18. The method of claim 17, wherein an aspect ratio of a thickness of the base layer to a width of the microchannel is about 0.5 to about 2.5.

19. The method of claim 17, wherein an aspect ratio of a thickness of the base layer to a width of the microchannel is about 2.

20. The method of claim 17, further comprising disposing a planar barrier adjacent the second surface of the base layer and positioned to overlay at least a portion of the microchannel, wherein the planar barrier reduces an ingress of material into the microchannel during molding of the closing layer as compared to a substantially similar base layer and microchannel without the planar barrier.
